(19) United States
(12) Patent Application Publication
(10) Pub. No.: US 2011/0056084 A1
(43) Pub. Date: Mar. 10, 2011

(54) Electric Cutting Tool

(75) Inventors: Atsuhito Okada, Fuchu-shi (JP); Akihiro Mikano, Fuchu-shi (JP)

(73) Assignee: RYOBI LTD., Fuchu-shi (JP)

(21) Appl. No.: 12/874,780

(22) Filed: Sep. 2, 2010

(30) Foreign Application Priority Data
Sep. 9, 2009 (JP) 2009-208109
Jun. 23, 2010 (JP) 2010-142507

(51) Int. Cl. B27B 9/02; B23D 45/16; B23D 47/00

(52) U.S. Cl. 30/376; 30/377; 83/522.18; 30/505

(57) ABSTRACT

An electric cutting tool includes: a surface plate; a body portion tiltably provided on the surface plate; and a circular saw blade capable of rotating by means of driving power from a driver. A movement amount measuring section measures a movement amount of the body portion with respect to the surface plate in response to a tilting action. A calculating section calculates a cutting depth of the circular saw blade or an inclination angle of the body portion on the basis of the movement amount measured by the movement amount measuring section. A display section displays the cutting depth or the inclination angle of the body portion calculated by the calculating section. The movement amount measuring section includes: a scale section installed on any one of the surface plate and the body portion; and a scale detecting section installed on the other.

### CROSS-REFERENCE TO RELATED APPLICATION

The present application relates to subject matter contained in Japanese Patent Application No. 2009-208109, filed on Sep. 9, 2009, and Japanese Patent Application No. 2010-142507, filed on Jun. 23, 2010, all of which are expressly incorporated herein by reference in their entirety.

### BACKGROUND OF THE INVENTION

1. Field of the Invention

The present invention relates to an electric cutting tool, and particularly, the present invention relates to an electric cutting tool in which a cutting depth (depth of cut) or an inclination angle of a circular saw blade is displayed at a position viewable for an operator.

2. Description of the Related Art

Heretofore, an electric cutting tool, including a surface plate, a body portion tiltably mounted on this surface plate and a circular saw blade rotatably provided by driving power from a driver included in the body portion, is known (for example, see Japanese Patent Application Publication No. 8-142001; hereinafter, referred to as “Patent Literature 1”). In a conventional electric cutting tool illustrated in Patent Literature 1, an indicator scale has generally been provided so that a cutting depth of the circular saw blade can be confirmed during an operation. However, since an operator has to confirm this indicator scale by sight, the indicator scale has a problem that it lacks in accuracy. Further, the indicator scale included in the conventional electric cutting tool must convert a circular motion, that is, a rotary motion of the circular saw blade into a linear dimension, that is, a cutting depth. For that reason, intervals of scale marks (measurements) necessarily become imbalanced like the indicator scale disclosed in Patent Literature 1. Therefore, it is hard for the operator to view and confirm the conventional indicator scale, and it is easy to generate an error.

On the other hand, Japanese Patent Application Publication No. 9-268516 (hereinafter, referred to as “Patent Literature 2”) discloses a technique for displaying a cutting depth with high accuracy. Patent Literature 2 discloses a concrete cutter with a display device capable of displaying the cutting depth of a blade. However, this concrete cutter with the cutting depth display device detects movement amounts of two members including an up-and-down arm and a frame, each of which carries out a circular motion, by means of a rack and a pinion; converts an amount of rotation of the pinion into an up-and-down amount of a mounting shaft of the blade; and thereby displays a cutting depth of the blade.

However, the technique disclosed in Patent Literature 2 mentioned above obtains the movement amount of the blade on the basis of the two members including the up-and-down arm and the frame, each of which carries out the circular motion. Thus, such a technique includes a structural problem that an error occurs inevitably. Therefore, even if the conventional techniques disclosed in Patent Literatures 1 and 2 mentioned above are combined, it is impossible to obtain an electric cutting tool capable of displaying a cutting depth and/or an inclination angle of a circular saw blade with high accuracy.

### SUMMARY OF THE INVENTION

The present invention has been made in order to solve the problem described above, and it is an object of the present invention to provide a new electric cutting tool capable of calculating a cutting depth and an inclination angle of a circular saw blade with high accuracy, and of displaying its calculation result by means of a display section arranged at a position viewable for an operator.

Hereinafter, the present invention will be described. In this regard, reference numerals of the appending drawings are added in parenthesis in order to facilitate understanding of the present invention. However, this does not cause the present invention to be limited in the illustrated forms.

In order to achieve the above object, the present invention is directed to an electric cutting tool. The electric cutting tool (10μ, 10′) according to the present invention includes: a surface plate (11); a body portion (21) tiltably provided on the surface plate (11); and a circular saw blade (41) capable of rotating by means of driving power from a driver (25) provided in the body portion (21). The electric cutting tool (10, 10′) also includes a movement amount measuring section (50, 50′, 50″, 80, 90) for measuring a movement amount of the body portion (21) with respect to the surface plate (11) in response to a tilting action. The electric cutting tool (10, 10′) also includes a calculating section (61) for calculating a cutting depth of the circular saw blade (41) or an inclination angle of the body portion (21) on the basis of the movement amount measured by the movement amount measuring section (50, 50′, 50″, 80, 90). The electric cutting tool (10, 10′) also includes a display section (62) for displaying the cutting depth or the inclination angle of the body portion (21) calculated by the calculating section (61).

In the electric cutting tool (10) according to the present invention, it is preferable that the movement amount measuring section (50, 50′, 50″, 80) includes: a scale section (51, 51′, 51″, 81) installed on any one of the surface plate (11) and the body portion (21), the scale section including scale marks provided at predetermined intervals; and a scale detecting section (52, 52′, 52″, 82) for detecting the scale marks included in the scale section (51, 51′, 51″, 81), the scale detecting section being installed on the other of the surface plate (11) and the body portion (21).

Further, in the electric cutting tool (10) according to the present invention, it is preferable that the scale section is a magnetic scale (51, 51′, 51″) in which the scale marks are recorded as magnetic patterns, and that the scale detecting section is a magnetic detecting head (52, 52′, 52″) for measuring the movement amount of the body portion (21) with respect to the surface plate (11) in response to the tilting action by reading out the scale marks from the magnetic scale and converting a read-out result into an electrical signal.

Further, in the electric cutting tool (10) according to the present invention, it is preferable that the scale section is a rack (81) in which teeth for the scale marks are cut at predetermined intervals, and the scale detecting section is a pinion (82) for measuring the movement amount of the body portion (21) with respect to the surface plate (11) in response to the tilting action by causing the pinion to carry out a rotary motion while engaging with the rack (81) and detecting an amount of rotary motion.

Moreover, in the electric cutting tool (10) according to the present invention, it is preferable that the body portion (21) includes: a gripper (28) used when a tilting operation of the body portion (21) is carried out; and a cover portion (27) that covers an outer circumference of the circular saw blade (41), wherein the display section (62) is installed at a region between the gripper (28) and the cover portion (27).

Furthermore, in the electric cutting tool (10, 10′) according to the present invention, it is preferable that the body portion (21) is configured so that the circular saw blade (41) can be tilted in a direction to be tilted to a side surface of the electric cutting tool, and that the calculating section (61) calculates the cutting depth of the circular saw blade (41) by carrying out correction in accordance with a tilt angle in a direction in which the circular saw blade (41) is to be tilted to the side surface.

Furthermore, in the electric cutting tool (10′) according to the present invention, it is preferable that the movement amount measuring section (90), the calculating section (61) and the display section (62) are integrally installed by means of a casing (64).

Further, in the electric cutting tool according to the present invention (10′), it is preferable that the calculating section (61), the display section (62) and the casing (64) are arranged so as not to protrude from an outline of the body portion (21).

Moreover, in the electric cutting tool (10′) according to the present invention, it is preferable that the electric cutting tool (10′) further includes: a link member (13) for linking the surface plate (11) to the body portion (21), the link member (13) extending along a tilt direction of the body portion (21) from an upper surface of the surface plate (11), that the movement amount measuring section includes an angle sensor (90) for detecting an inclination angle of the link member (13) with respect to the surface plate (11), and that the calculating section (61) calculates the cutting depth of the circular saw blade (41) or the inclination angle of the body portion (21) on the basis of the inclination angle detected by the angle sensor (90).

Furthermore, in the electric cutting tool (10′) according to the present invention, it is preferable that the body portion (21) includes a cover portion (27) that covers an outer circumference of the circular saw blade (41), the cover portion (27) capable of tilting with respect to the surface plate (11) together with the circular saw blade (41), that the movement amount measuring section includes an angle sensor (90) for detecting an inclination angle of the cover portion (27) with respect to the surface plate (11), and that the calculating section (61) calculates the cutting depth of the circular saw blade (41) or the inclination angle of the body portion (21) on the basis of the inclination angle detected by the angle sensor (90).

According to the present invention, it is possible to provide a new electric cutting tool capable of calculating a cutting depth or an inclination angle of a circular saw blade with high accuracy, and of displaying its calculation result by means of a display section arranged at a position viewable for an operator.

### BRIEF DESCRIPTION OF THE DRAWINGS

The foregoing and other objects, features and advantages of the present invention will become more readily apparent from the following detailed description of preferred embodiments of the present invention that proceed with reference to the appending drawings:

FIG. 1 is an external front view of an electric cutting tool according to the present invention;

FIG. 2 is an external back view of the electric cutting tool according to the present invention;

FIG. 3 is an external right side view of the electric cutting tool according to the present invention;

FIG. 4 is an external left side view of the electric cutting tool according to the present invention;

FIG. 5 is a cross-sectional view for explaining an internal configuration of the electric cutting tool according to the present invention, and shows a cross-sectional view taken along the line A-A in FIG. 4;

FIG. 6 is a partially broken-out top view of the electric cutting tool according to the present invention;

FIG. 7 is a schematic right side view in which a part of the members is omitted for explaining an operation of the electric cutting tool according to the present invention, and particularly shows a state when a body portion is in the closest position to a surface plate;

FIG. 8 is a schematic right side view in which a part of the members is omitted for explaining an operation of the electric cutting tool according to the present invention, and particularly shows a state when the body portion is tilted upward with respect to the surface plate;

FIG. 9 is a block diagram for explaining a main configuration of the electric cutting tool according to the present invention;

FIG. 10 is a view illustrating a modified form that a movement amount measuring section according to the present invention can take;

FIG. 11 is a view illustrating another modified form that the movement amount measuring section according to the present invention can take;

FIG. 12 is a view illustrating still another modified form that the movement amount measuring section according to the present invention can take;

FIG. 13 is a schematic right side view for illustrating another embodiment of the movement amount measuring section according to the present invention;

FIG. 14 is a partially broken-out top view illustrating another embodiment of the movement amount measuring section according to the present invention;

FIG. 15 is a view illustrating a modified form of the electric cutting tool according to the present invention shown in FIG. 7;

FIG. 16 is an external left side view of the electric cutting tool according to a modified form that the present invention can take;

FIG. 17 is a partially broken-out top view of the electric cutting tool according to the modified form;

FIG. 18 is an enlarged cross-sectional view of a main part of FIG. 17;

FIG. 19 is a view illustrating another modified form that a pivot and an angle sensor shown in FIG. 18 can take;

FIG. 20 is a view illustrating still another modified form that the pivot and the angle sensor shown in FIG. 18 can take;

FIG. 21 is a view illustrating a modified form of the electric cutting tool according to the present invention shown in FIG. 1;

FIG. 22 is a view illustrating a modified form of the electric cutting tool according to the present invention shown in FIG. 2;

FIG. 23 is a schematic view showing a state where the cutting depth in a perpendicular direction to a processed material changes when the circular saw blade is inclined in a horizontal direction;

FIG. 24 is a view showing a desktop type sliding circular saw to which the present invention can be applied; and

FIG. 25 is a view for explaining a method of adjusting a cutting depth in the desktop type sliding circular saw shown in FIG. 24.

### DETAILED DESCRIPTION OF THE INVENTION

Hereinafter, preferred embodiments for implementing the present invention will be described with reference to the appending drawings. In this regard, the embodiments described below do not tend to limit the invention as claimed in each of the claims described below. Further, it is not always true that all of combinations of the features explained in the embodiments are essential for elements of the present invention.

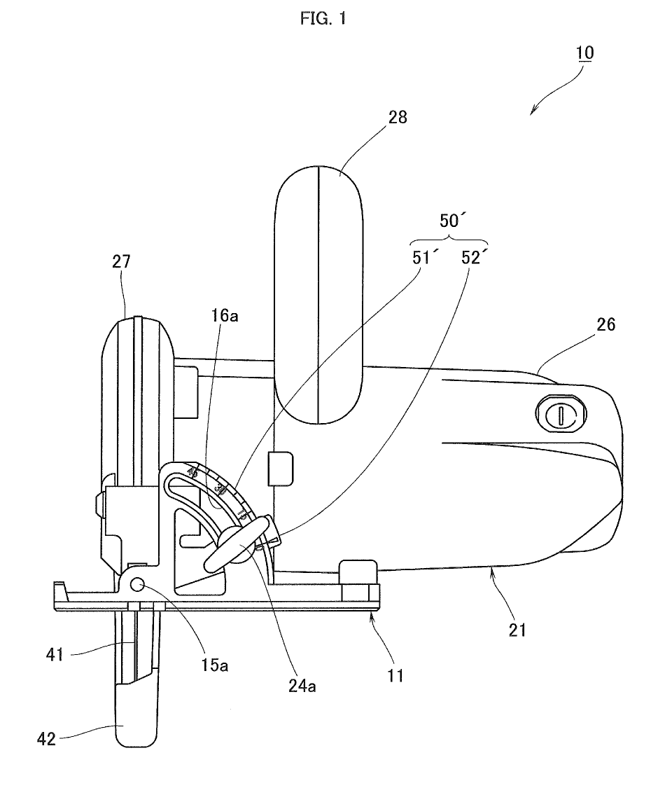

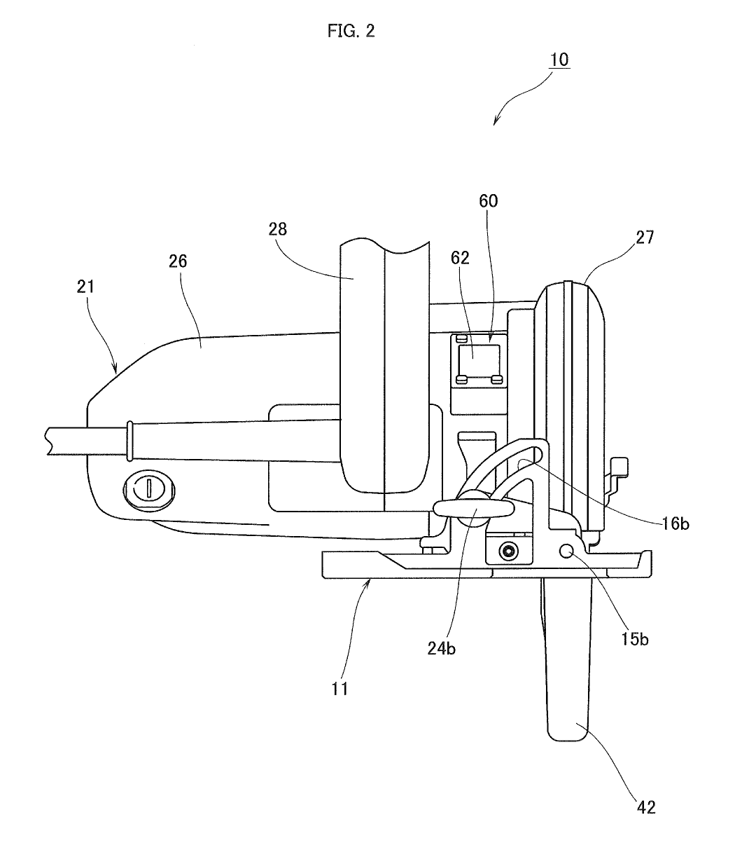

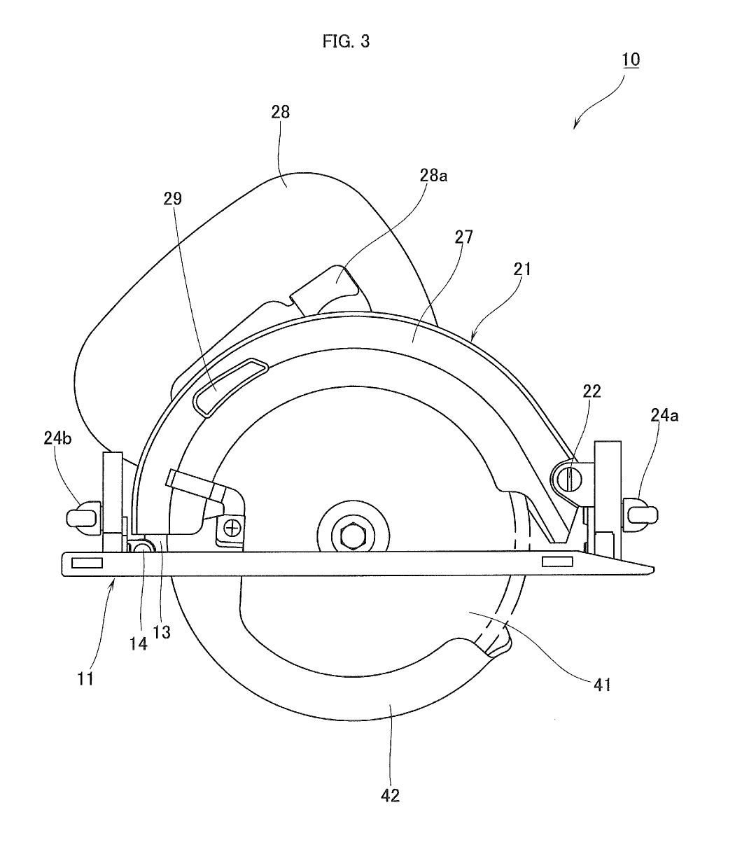

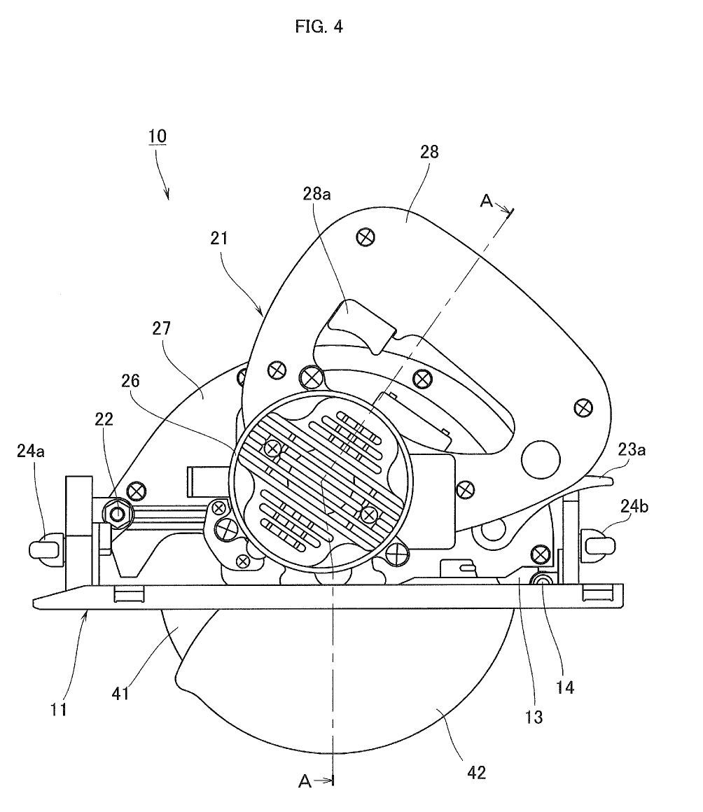

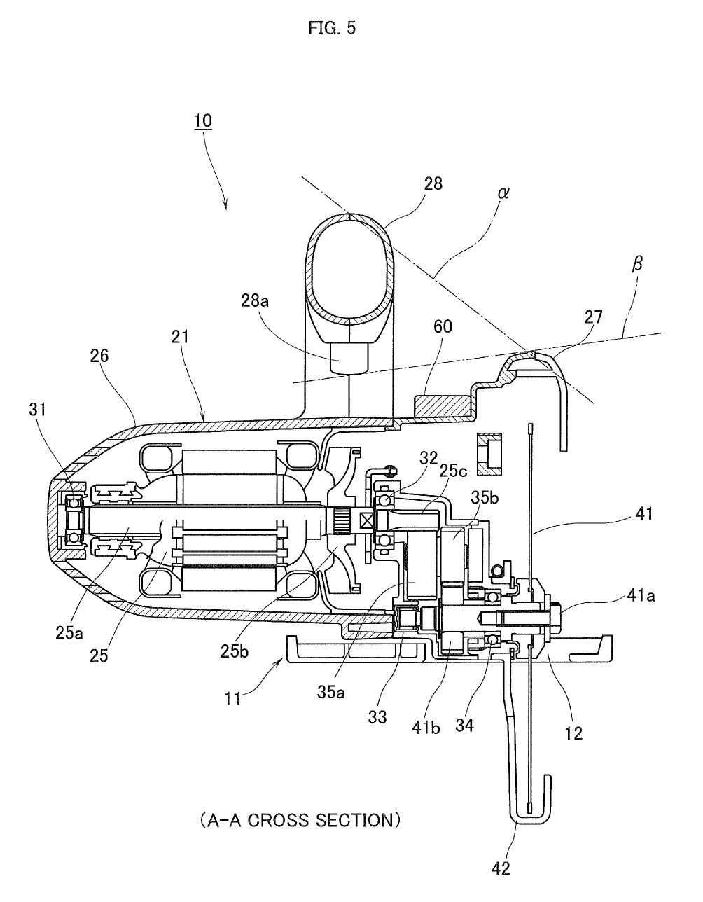

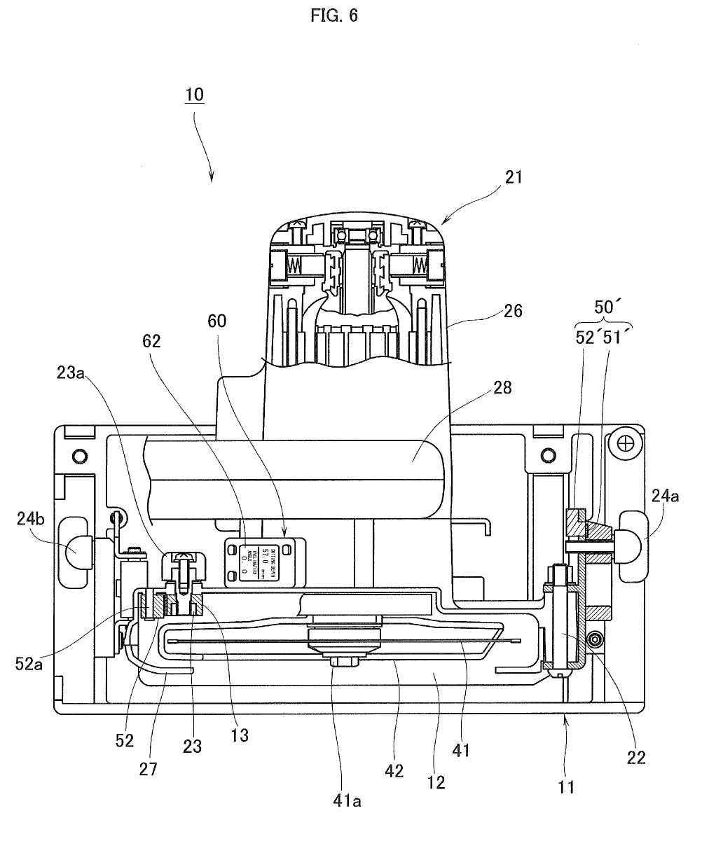

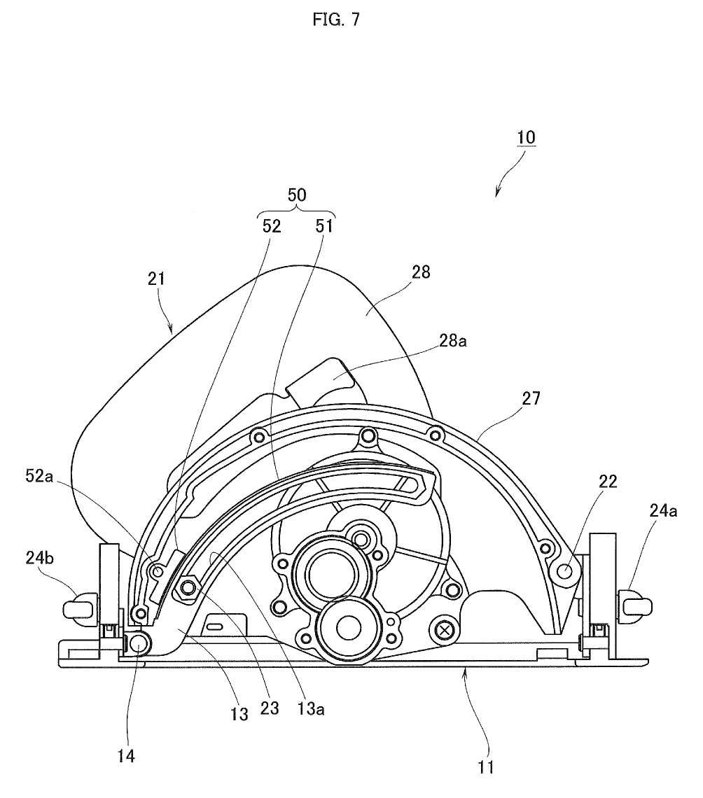

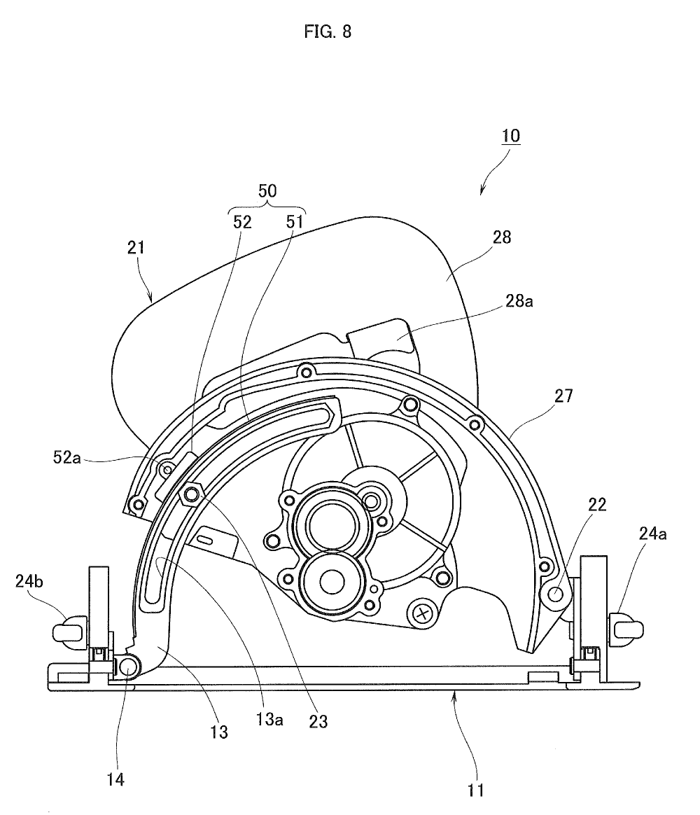

A basic structure of an electric cutting tool according to the present invention will first be described with reference to FIG. 1 to FIG. 8. Here, FIG. 1 is an external front view of the electric cutting tool according to the present invention. FIG. 2 is an external back view of the electric cutting tool according to the present invention. FIG. 3 is an external right side view of the electric cutting tool according to the present invention. FIG. 4 is an external left side view of the electric cutting tool according to the present invention. Further, FIG. 5 is a cross-sectional view for explaining an internal configuration of the electric cutting tool according to the present invention, and shows a cross-sectional view taken along the line A-A in FIG. 4. Moreover, FIG. 6 is a partially broken-out top view of the electric cutting tool according to the present invention. FIG. 7 and FIG. 8 are schematic right side views in each of which a part of the members is omitted for explaining an operation of the electric cutting tool according to the present invention. In particular, FIG. 7 shows a state when the body portion 21 is in the closest position to the surface plate 11. FIG. 8 shows a state when the body portion 21 is tilted upward with respect to the surface plate 11. In this regard, the case where the electric cutting tool 10 according to the present invention is configured as a handheld radial arm saw is illustrated. Further, directions defined in the present specification match those expressed in “brief description of the drawings” described above, but these directions are defined so as to fit with directions when viewed from an operator who operates an electric cutting tool 10.

The electric cutting tool 10 according to the present invention is configured so as to include: a surface plate 11 mounted on a processed material; a body portion 21 tiltably provided on this surface plate 11; and a circular saw blade 41 capable of rotating by means of driving power from a driver such as a motor 25 provided in the body portion 21.

The surface plate 11 is a member on which the body portion 21 is installed. The surface plate 11 is configured so as to have a substantially rectangular shape when viewed from the above (see FIG. 6). Further, a bottom surface of the surface plate 11 is formed as a flat and smooth surface so that the electric cutting tool 10 can stably be mounted on a processed material. By operating the electric cutting tool 10 while causing the bottom surface of the surface plate 11 to slide on the processed material, a stable cutting operation can be made.

An opening portion 12 is formed in this surface plate 11. The opening portion 12 allows the circular saw blade 41 included in the body portion 21 to move up and down. An operator can specify a cutting position of a processed material by viewing the processed material from this opening portion 12. In this regard, although it is not shown in the drawings, a mark or the like, which becomes alignment for cutting, is formed in the vicinity of the opening portion 12 on an upper surface of the surface plate 11. Accurate processing can be made by carrying out the cutting processing while aligning this mark with an ink line drawn on a processed material.

Further, a safety cover 42 (to be described later) passes through the opening portion 12. The safety cover 42 is provided for a lower circumference of the circular saw blade 41. For that reason, the opening portion 12 having a shape based on shapes of the circular saw blade 41, the safety cover 42 and the like is adopted. In particular, swarf generated from a processed material by means of the rotating circular saw blade 41 is rolled up when cutting processing is carried out. However, since the opening portion 12 is formed so as to be narrowed to a minimum necessary opening range, it is possible to effectively prevent swarf from depositing on the surface plate 11.

The body portion 21 is installed above the surface plate 11 described above in a tiltable state in an up-and-down (vertical) direction (that is, a direction along a rotational direction of a circular saw blade 41) and a right-and-left (horizontal) direction (that is, a direction in which the circular saw blade 41 is to be tilted to the side surface). A connecting structure between the surface plate 11 and the body portion 21 for achieving such an action will be described. At a front side of the electric cutting tool 10, the body portion 21 is rotatably connected to the surface plate 11 via a pivot 22. The body portion 21 is configured so that a back side of the body portion 21 can be tilted to the vertical direction with respect to the surface plate 11 using this pivot 22 as the center of rotation. Therefore, the operator is allowed to tilt the back side of the body portion 21 to the vertical direction with respect to the surface plate 11, and to move the circular saw blade 41 to a direction along the rotational direction of the circular saw blade 41 by causing the circular saw blade 41 to protrude or retract from the opening portion 12 of the surface plate 11. The operator can thus carry out cutting processing by means of the circular saw blade 41. Further, it is possible to adjust a cutting depth (depth of cut) by adjusting an amount of protrusion of the circular saw blade 41.

In order to fix the body portion 21 described above to a desired tilt position, a link member 13 is installed at the upper surface in the back side direction of the surface plate 11 (see FIG. 7 and the like). This link member 13 is a member formed so as to extend along a tilt direction of the body portion 21 from the upper surface of the surface plate 11. A connecting end to the surface plate 11 is tiltably linked to the body portion 21 via the shaft member 14. Further, a guide hole 13a is formed in a body of the link member 13. This guide hole 13a is formed as an opening with a step as shown in FIG. 7. An engaging nut 23 is fitted into a step portion of the guide hole 13a. A lever 23a with a screw shaft is attached to the engaging nut 23 by screwing together so as to sandwich the step portion of the guide hole 13a between the engaging nut 23 and the lever 23a. Fastening and loosening of the engaging nut 23 can be carried out by operating the lever 23a. Namely, by operating the lever 23a to loosen fastening of the engaging nut 23 against the guide hole 13a of the link member 13, it becomes possible to tilt the body portion 21 to a desired tilt position. Moreover, by operating the lever 23a at a desired position to carry out fastening of the engaging nut 23 against the guide hole 13a of the link member 13, it becomes possible to fix the body portion 21 with a desired tilt position.

On the other hand, as shown in FIG. 1 and FIG. 2, the surface plate 11 is connected to the body portion 21 by means of shaft members 15a, 15b even on its front surface and back surface. By using the shaft members 15a, 15b as the center of tilt, it is possible to tilt the body portion 21 in the horizontal direction (that is, a direction in which the circular saw blade 41 is to be tilted to the side surface). Further, guide holes 16a, 16b for defining a tilting range in the horizontal direction of the body portion 21 are formed on both the front side and the back side of the surface plate 11. Fixing screws 24a, 24b included in the body portion 21 pass through and are installed in the two guide holes 16a, 16b. A tilt angle of the circular saw blade 41 in the direction to be tilted to the side surface is adjusted by causing the body portion 21 to be tilted in the horizontal direction with respect to the surface plate 11, and the fixing screws 24a, 24b are then fastened to the guide holes 16a, 16b, whereby the body portion 21 is fixed. For that reason, the body portion 21 can be fixed at a desired right or left tilt position. Namely, it is possible to set up a desired tilt angle of the circular saw blade 41 in the direction to be tilted to the side surface with respect to the circular saw blade 41.

The body portion 21 includes: a housing 26 for receiving (or housing) the motor 25 that is a driving source; a cover portion 27 that covers an upper portion of the circular saw blade 41; and a handle 28 as a gripper (gripping section), which is formed on an upper portion of the housing 26 for operating the electric cutting tool 10.

A switch lever 28a for driving rotation of the circular saw blade 41 is provided in the handle 28. When the operator presses the switch lever 28a, the motor 25 is driven. Thus, the cutting processing can be implemented by transmitting rotary driving power to the circular saw blade 41.

Further, as shown in FIG. 3, an opening 29 is provided at the back of the cover portion 27. This opening 29 allows swarf generated by a cutting motion of the circular saw blade 41 when the electric cutting tool 10 is used to be discharged to the outside of the cover portion 27.

Moreover, a lower half of the circular saw blade 41 is covered by the safety cover 42. The safety cover 42 is configured so as to be tilted and stored in the inside of the cover portion 27 that covers the circular saw blade 41 by being pressed by means of a processed material when the processed material is cut. This makes it possible to ensure safety for the operator while the cutting motion is not inhibited.

As shown in FIG. 5, the motor 25 that is a driving source and a plurality of gear groups for transmitting rotary driving power of the motor 25 to the circular saw blade 41 as a rotary driving power transmitter are housed (or stored) in the inside of the housing 26.

A fan 25b is fixed at a front side of a motor shaft 25a included in the motor 25. The fan 25b is rotated when the motor 25 is driven, whereby cooled wind is introduced into the housing 26. Therefore, the motor 25 and the like that become a heat generating source are cooled suitably, and the electric cutting tool 10 can be operated suitably.

Further, both ends of the motor shaft 25a included in the motor 25 are supported by bearings 31, 32, respectively. A start gear 25c is formed at an end portion of the front side of the motor shaft 25a. On the other hand, a saw blade shaft 41a in which the circular saw blade 41 is installed via the plurality of gear groups is installed under the start gear 25c. The saw blade shaft 41a is supported to the inside of the housing 26 via bearings 33, 34. Such a configuration causes a substantially lower half of the circular saw blade 41 to protrude downward from a lower end of the housing 26 via the opening portion 12 of the surface plate 11. In this regard, an end gear 41b is fixed at a tip portion of the saw blade shaft 41a that enters the housing 26.

As shown in FIG. 5, the gear groups for connecting the start gear 25c to the end gear 41b are constructed by a first gear 35a and a second gear 35b that become intermediate gears. The first gear 35a and the second gear 35b are aligned on the same shaft in series and are fixed on the shaft.

In the electric cutting tool 10 according to the present invention having such a configuration, the rotary driving power of the motor 25 is transmitted from the start gear 25c of the motor shaft 25a to the end gear 41b via the first gear 35a and the second gear 35b, and is finally transmitted to the saw blade shaft 41a. As a result, the circular saw blade 41 is configured to be rotatively driven.

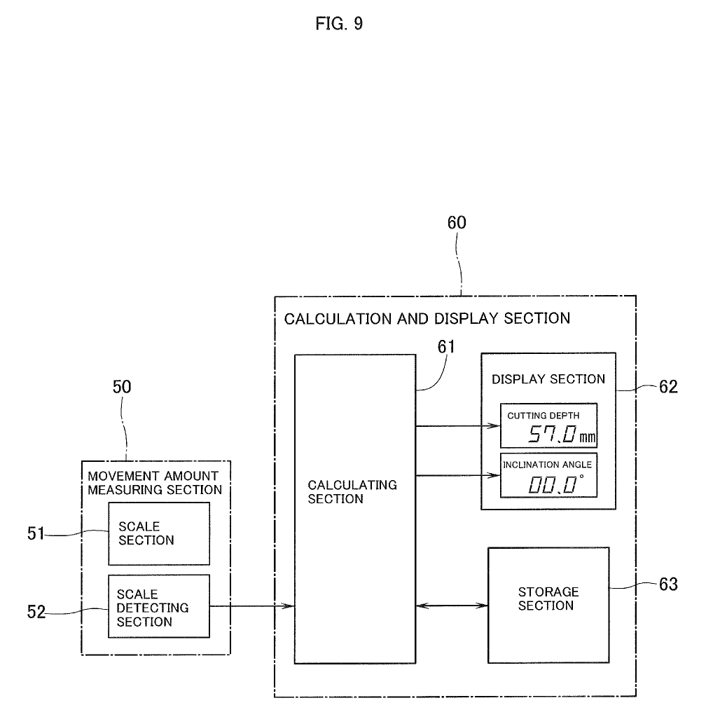

The electric cutting tool 10 according to the present invention has a basic configuration explained above. Moreover, the electric cutting tool 10 also has a significant configuration in which a cutting depth and/or an inclination angle of the circular saw blade 41 can be calculated with high accuracy and its calculation result can be displayed at a place arranged at a position viewable for the operator. Now, significant features that the electric cutting tool 10 according to the present invention has will be described using FIG. 5 to FIG. 8 and adding FIG. 9 thereto as a new reference drawing. In this regard, FIG. 9 is a block diagram for explaining a main configuration of the electric cutting tool 10 according to the present invention.

The electric cutting tool 10 according to the present invention includes a movement amount measuring section 50 for measuring a movement amount (distance) of the body portion 21 with respect to the surface plate 11 in response to a tilting action. This movement amount measuring section 50 is configured as an incremental type of encoder that is a conventional technique. Namely, the movement amount measuring section 50 according to the present embodiment is configured by a magnetic scale 51 and a magnetic detecting head 52. The magnetic scale 51 is installed on the link member 13 included in the surface plate 11. The magnetic detecting head 52 is installed within the cover portion 27 included in the body portion 21.

The magnetic scale 51 is a member configured as a scale section including scale marks (measurements) arranged at predetermined intervals. More specifically, minute magnetic patterns are recorded in a magnet material, and are utilized as scale marks of a scale (or ruler). The magnetic scale 51 is attached onto the upper side of the link member 13 formed so as to extend along a tilt direction of the body portion 21.

On the other hand, the magnetic detecting head 52 is a member configured as a scale detecting section for detecting the scale marks included in the magnetic scale 51 configured as a scale section. More specifically, the magnetic detecting head 52 is one for measuring a movement amount (distance) of the body portion 21 with respect to the surface plate 11 in response to a tilting action by reading out scale marks of the magnetic scale 51 and converting a read-out result into an electrical signal.

In this regard, the magnetic detecting head 52 is swingably attached so as to have a shaft member 52a and move along the magnetic scale 51 attached onto the upper side of the link member 13. For example, when a state of the body portion 21 is shifted from a state where the body portion 21 is held up (or lifted) upward as shown in FIG. 8 to a state where the body portion 21 is depressed downward as shown in FIG. 7, the magnetic detecting head 52 relatively slides on the magnetic scale 51 along a surface of the magnetic scale 51 above the link member 13, and they can fulfill the function as the movement amount measuring section 50 suitably.

On the other hand, a calculation and display section 60 is installed between the handle 28 as the gripper included in the body portion 21 and the cover portion 27 (see FIG. 5 and FIG. 6). This calculation and display section 60 includes: at least a calculating section 61 as a CPU (Central Processing Unit) used to calculate a cutting depth of the circular saw blade 41 or an inclination angle of the body portion 21 on the basis of a movement amount (distance) obtained by the movement amount measuring section 50 described above; and a display section 62 as a digital liquid crystal screen used to display the cutting depth or the inclination angle of the body portion 21 calculated by the calculating section 61. Moreover, in the present embodiment, the calculation and display section 60 is configured so as to include a storage section 63 as a HDD (Hard disk drive). Data calculated by the calculating section 61, basic data and arithmetic expressions of the electric cutting tool 10 used for calculation are stored in the storage section 63.

In this regard, an installed position of the calculation and display section 60 is provided between the handle 28 and the cover portion 27 as shown in FIG. 2, FIG. 5 and FIG. 6. For this reason, it becomes an installed position remarkably viewable for the operator. Further, as shown in FIG. 5 particularly, the electric cutting tool 10 is configured so that a height of the calculation and display section 60 is lower than a virtual line α connecting an uppermost position of the handle 28 and an uppermost position of the cover portion 27 when the A-A cross section is viewed, and the height of the calculation and display section 60 is further lower than a virtual line β connecting a lowermost position of the switch lever 28a included in the handle 28 and the uppermost position of the cover portion 27. Such a configuration fulfills a suitable effect that it is easy for the operator to view the calculation and display section 60 and it does not disturb the operator who grips the handle 28. A form and an arrangement of the calculation and display section 60 are adopted in view of operability of the electric cutting tool 10. Moreover, by making the installed position of the calculation and display section 60 lower than the virtual line α, it is possible to avoid contact of an object with the calculation and display section 60 and application of impact force even though the electric cutting tool 10 is hit with the object or dropped on the ground. Therefore, it is possible to reduce the possibility that the calculation and display section 60 is damaged or broken down.

In the present embodiment, when the body portion 21 is operated, the magnetic detecting head 52 sliding on the magnetic scale 51 measures a movement amount (distance) of the body portion 21 with respect to the surface plate 11 in response to a tilting action. Data obtained by the measurement are transmitted (or sent) from the magnetic detecting head 52 that is the scale detecting section to the calculating section 61. The calculating section 61 obtaining measured data on the movement amount (distance) of the body portion 21 converts the measured data into a cutting depth of the circular saw blade 41. On this conversion, the calculating section 61 reads out calculation conditions, in which a conversion expression based on a shape of the electric cutting tool 10 stored in the storage section 63, a diameter of the circular saw blade 41 and the like are set up in advance, from the storage section 63, and calculates the cutting depth and/or the inclination angle of the circular saw blade 41. A calculation result obtained by the calculating section 61 is transmitted to the display section 62, and is instantly displayed on the digital liquid crystal screen included in the display section 62.

In this regard, the display section 62 allows a desired display form to be selected from various display forms. For example, a display unit of the cutting depth can be converted into any of various units such as “inch” based on the Imperial system and “Cun (=3.03 centimeters)” based on the Japanese measuring system in addition to “millimeter (mm)” based on the SI system of unit, and a converted unit can be displayed. In such a conversion and display process, when the operator pushes a unit switching button (not shown in the drawings), a unit switching command by an electrical signal is transmitted from the display section 62 to the calculating section 61, and the calculating section 61 receiving this command again transmits a display command by a new unit to the display section 62. This makes it possible to achieve selection of the display form.

The movement amount measuring section according to the present embodiment can measure not only a movement amount of the body portion 21 in response to a tilting action in a vertical direction (that is, a direction along a rotational direction of the circular saw blade 41), but also a movement amount by a tilting action in a horizontal direction (that is, a direction in which the circular saw blade 41 is to be tilted to the side surface). For example, as shown in FIG. 1 and FIG. 6, a magnetic scale 51′ is attached to an upper surface of a member in which the guide hole 16a for defining the tilting range of the body portion 21 in the horizontal direction is formed, and a magnetic detecting head 52′ is installed at a side of the body portion 21, which faces this magnetic scale 51′. Thus, a movement amount measuring section 50′ capable of fulfilling a function similar to that of the movement amount measuring section 50 described above can be configured. In the case of the movement amount measuring section 50′, the calculating section 61 calculates measured data of the movement amount (distance) obtained by the magnetic detecting head 52′ as the inclination angle of the body portion 21 with similar processing to the above processing. The inclination angle of the body portion 21 thus obtained is instantly displayed on the digital liquid crystal screen included in the display section 62. However, even in this case, any display form can be selected. For example, the display form can be changed into desired representation such as representation by “prime (′)” and “radian (rad)” in addition to “degree (°)”.

In this regard, the movement amount measuring sections 50, 50′ described above are configured as the incremental type of encoder that is a known art. Although explanation of its principle of operation is omitted, it is noted that an operation to carry out zero point adjustment and the like are required for every measurement.

As described above, the suitable embodiment of the present invention has been explained, but a technical scope of the present invention is not limited to the scope described in the above embodiment. A variety of changes and modifications can be added to the above embodiment.

For example, although a tip saw has been used as the circular saw blade 41 according to the embodiment described above, the present invention can be applied to any form of circular saw blade such as a diamond plate and a cutter for digging a groove.

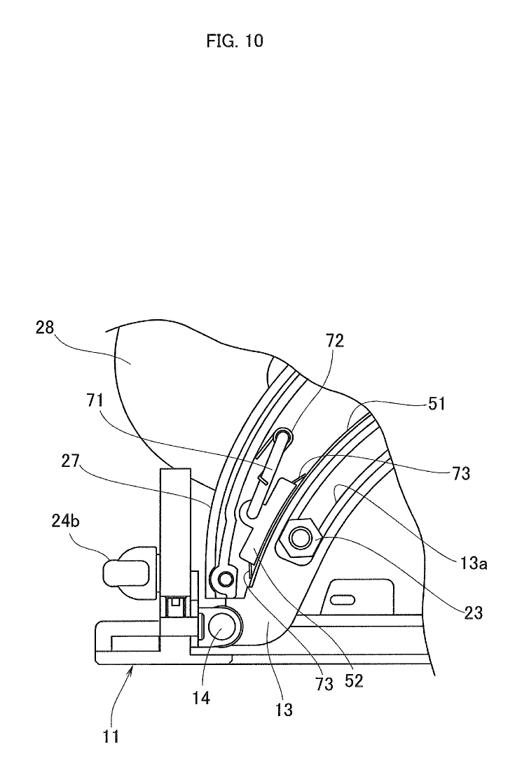

Further, for example, in the embodiment described above, as shown in FIG. 7, the magnetic detecting head 52 was swingably attached via the shaft member 52a so as to move along the magnetic scale 51 attached onto the upper side of the link member 13. However, means for attaching the magnetic detecting head 52 in a swingable state is not limited to one in which the shaft member 52a is used. As a concrete modified example, as shown in FIG. 10, a configuration in which a magnetic detecting head 52 is connected to an inner surface of a cover portion 27 via a tiltable link arm 71 and a torsion coil spring 72 is installed on this link arm 71 can be adopted. According to such a configuration, elastic force of the torsion coil spring 72 is always exerted on the magnetic detecting head 52 via the link arm 71, and the magnetic detecting head 52 is always pressed to the magnetic scale 51. For that reason, it is possible to maintain a suitable measurement state. In this regard, by providing packing members 73, 73 made of an elastic member such as a rubber plate in the vicinity of contact points of the magnetic detecting head 52 with the magnetic scale 51, it is possible to prevent refuse such as swarf and dust from entering between the magnetic scale 51 and the magnetic detecting head 52. Thus, it is preferable.

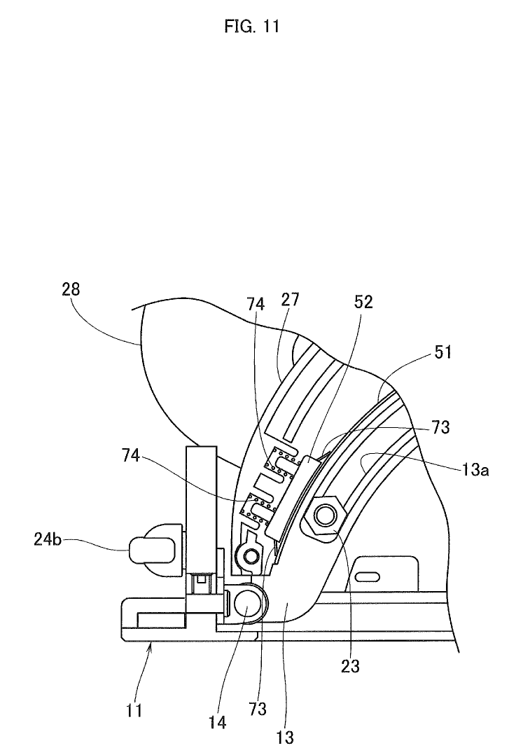

Further, for example, as shown in FIG. 11, means capable of always pressing the magnetic detecting head 52 toward the magnetic scale 51 suitably can be realized by providing a compression coil spring 74 between the magnetic detecting head 52 and the inner surface of the cover portion 27. By using the compression coil spring 74 illustrated in FIG. 11, operations and effects similar to those realized by the link arm 71 and the torsion coil spring 72 can also be obtained.

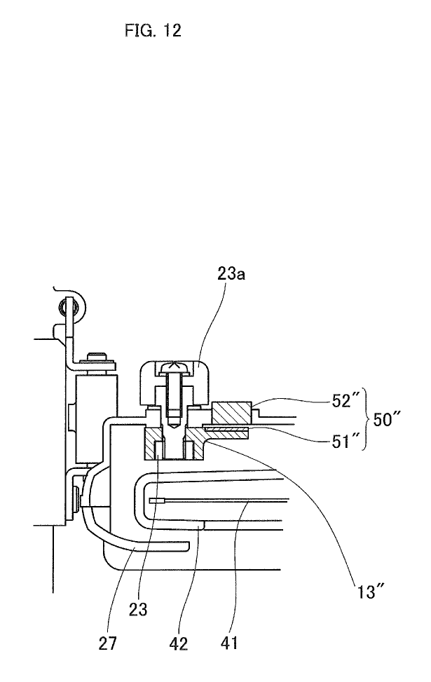

Further, an arrangement position of the magnetic scale 51 and the magnetic detecting head 52 that construct the movement amount measuring section 50 is not limited to the embodiment described above. Any modified form can be adopted within a range capable of fulfilling the similar function. In the embodiment described above, as shown in FIG. 7 and the like, the magnetic scale 51 and the magnetic detecting head 52 are arranged so as to face each other in the vertical direction. However, for example, as shown in FIG. 12, a magnetic scale 51″ and a magnetic detecting head 52″ that construct a movement amount measuring section 50″ can be arranged so as to face each other in the horizontal direction. In this case, as a member in which the magnetic scale 51″ and the magnetic detecting head 52″ are installed, any form arbitrarily changed depending upon a condition of the arrangement place can be adopted. For example, as shown in FIG. 12, by using a link member 13″ including a flange-like shape, the magnetic scale 51″ can be arranged at a stable place on which maintenance or the like is easily carried out.

Further, although the case where each of the movement amount measuring sections 50, 50′, 50″ according to the present embodiment described above is configured as an incremental type of encoder has been illustrated, the movement amount measuring section of the present invention can be configured as a capacitive absolute encoder. By adopting an absolute encoder as the movement amount measuring section, it is not required to carry out zero point adjustment for every measurement. This makes it possible to improve handleability thereof dramatically.

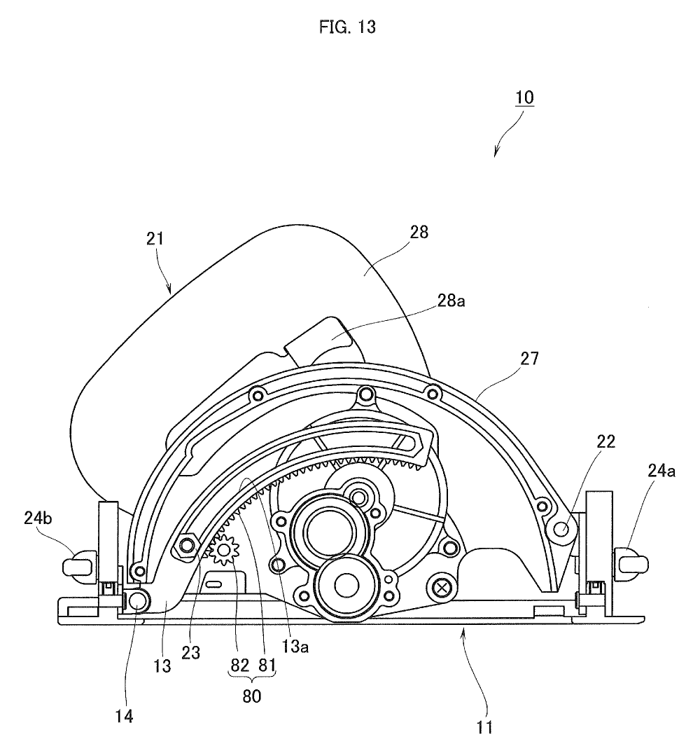

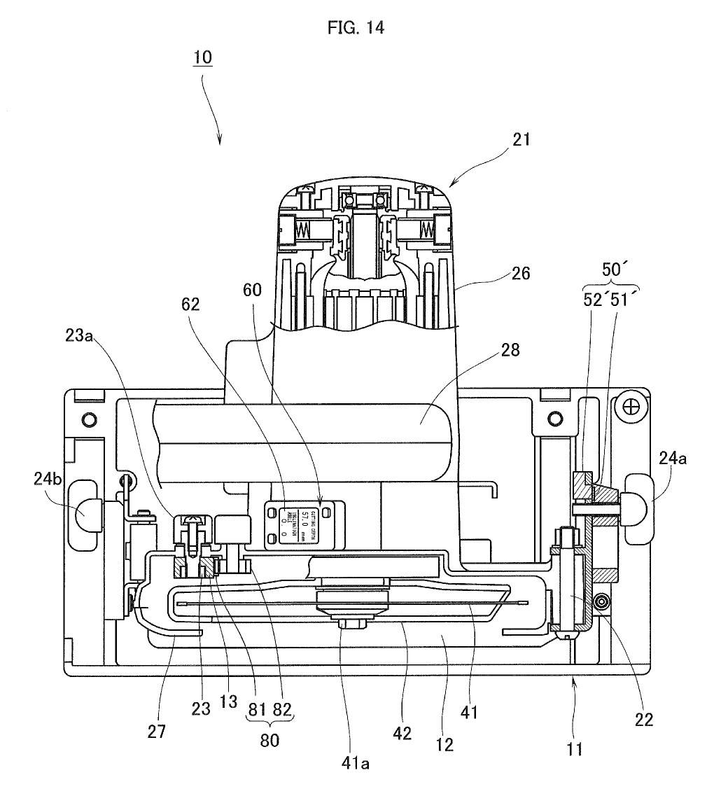

Further, the scale section and the scale detecting section constructing the movement amount measuring section according to the present invention are not limited to the magnetic scales 51, 51′, 51″ and the magnetic detecting heads 52, 52′, 52″ as described above, respectively. For example, FIG. 13 and FIG. 14 are views for illustrating another embodiment of the movement amount measuring section according to the present invention. As shown in FIG. 13 and FIG. 14, the scale section can be configured as a rack 81 in which teeth for scale marks are cut at predetermined intervals, and the scale detecting section can be configured as a pinion 82 for measuring a movement amount (distance) of the body portion 21 with respect to the surface plate 11 in response to a tilting action by causing the pinion 82 to carry out a rotary motion while engaging with the rack 81 and detecting an amount of rotary motion. By constructing a movement amount measuring section 80 by the rack 81 and the pinion 82 in this manner and obtaining the amount of rotation of the pinion 82 by means of the calculating section 61, the movement amount (distance) of the body portion 21 with respect to the surface plate 11 can be grasped. Therefore, the cutting depth of the circular saw blade 41 can be calculated on the basis of the measured data, and the calculation result can be displayed on the display section 62.

Further, the storage section 63 included in the calculation and display section 60 according to the present embodiment as described above can be omitted. Namely, in the case where a configuration in which the calculation process is carried out using the calculating section 61 and the calculation result and the like are not stored is selected, it is possible to obtain a reduction effect of production costs by omitting the storage section 63.

Further, each of the movement amount measuring sections 50, 50′, 50″ according to the present embodiment described above is one that detects a moving distance of a member. However, values detected by the movement amount measuring section of the present invention are not limited to the moving distance data. For example, the movement amount measuring section of the present invention can be configured so as to detect a movement amount as inclination angle data.

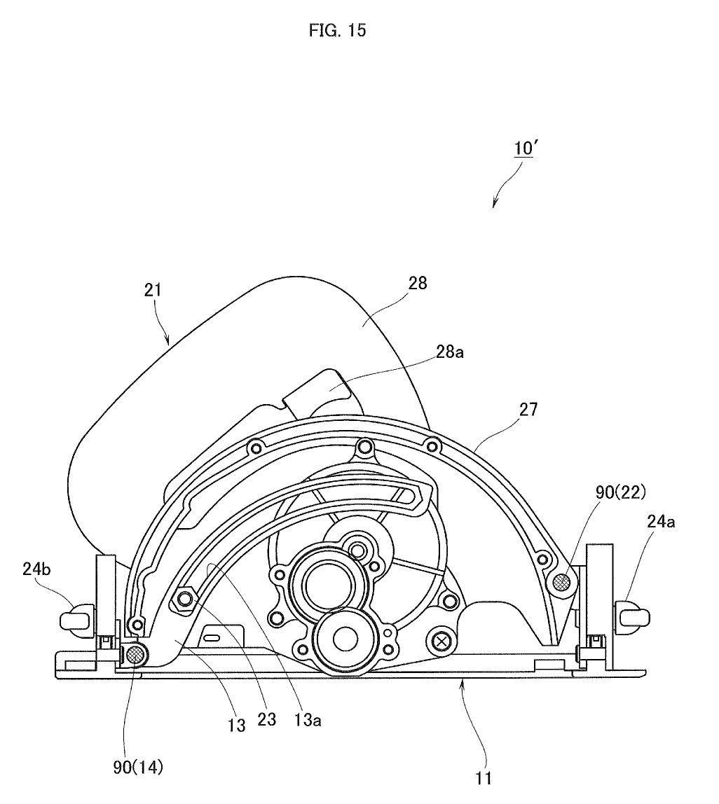

More specifically, as the electric cutting tool 10′ shown in FIG. 15, which illustrates a modified form of the electric cutting tool 10 according to the present invention shown in FIG. 7, an angle sensor 90 as the movement amount measuring section is provided at a position of a shaft member (14) for tiltably linking the link member 13 to the surface plate 11, and a tilt angle of the link member 13 with respect to the surface plate 11 is measured. This makes it possible to obtain a cutting depth or an inclination angle of the circular saw blade 41 with high accuracy. The angle sensor 90 installed at the portion of the shaft member (14) detects the movement amount as inclination angle data. Such a configuration can also be adopted suitably as the movement amount measuring section of the present invention.

In this regard, as shown in FIG. 15, the angle sensor 90 can also be installed at a portion of a pivot (22) for rotatably connecting the body portion 21 to the surface plate 11 in addition to the portion of the shaft member (14). A cutting depth and/or an inclination angle of the circular saw blade 41 can also be obtained with high accuracy by measuring a tilt angle of the body portion 21 with respect to the surface plate 11. In this regard, two angle sensors 90 have been illustrated at two portions including the portion of the shaft member (14) and the portion of the pivot (22) in FIG. 15. This is drawn for illustrating installable portions of the angle sensor 90. So long as the angle sensor 90 is provided at any one portion, it is possible to suitably fulfill the function as the movement amount measuring section according to the present invention (of course, a plurality of angle sensors 90 each of which fulfills the same function may be provided at a plurality of portions).

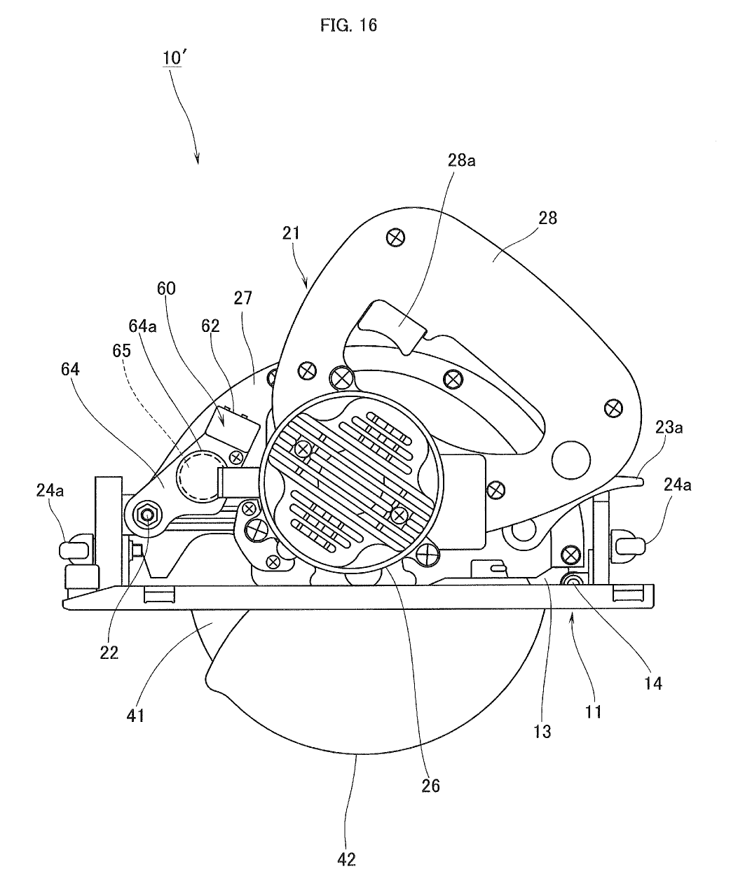

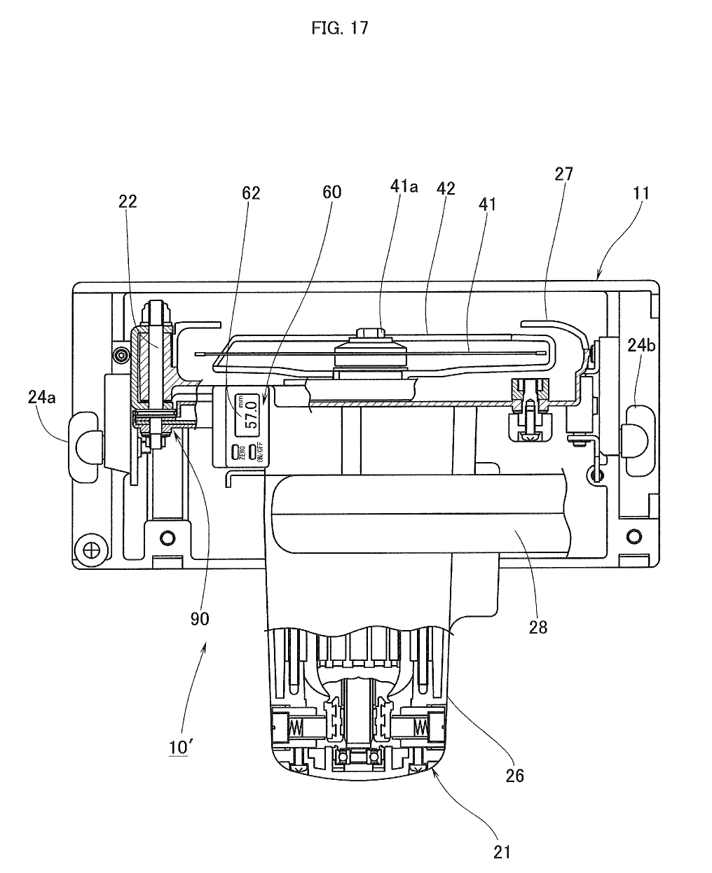

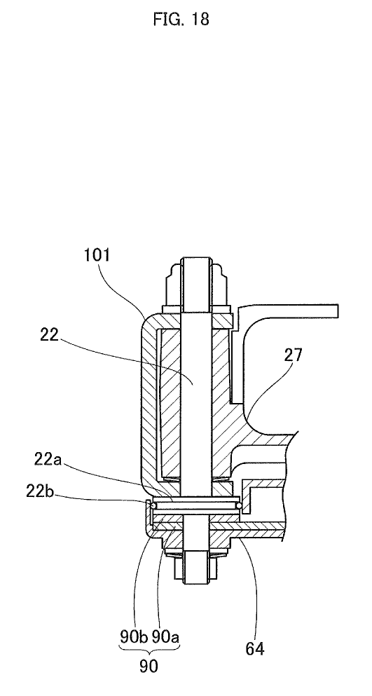

Here, a concrete example of the case where the angle sensor 90 is provided at the portion of the pivot (22) will be described with reference to FIG. 16 to FIG. 18. Here, FIG. 16 is an external left side view of the electric cutting tool 10′ according to the modified form that the present invention can take. FIG. 17 is a partially broken-out top view of the electric cutting tool 10′ according to the modified form. Further, FIG. 18 is an enlarged cross-sectional view of a main part of FIG. 17.

In the electric cutting tool 10′ shown in FIG. 16 to FIG. 18, the pivot 22 is installed fixedly to a supporting member 101 installed fixedly to the surface plate 11. Moreover, the cover portion 27 included in the body portion 21 is tiltably connected to this pivot 22 (see FIG. 18, particularly).

A flange portion 22a is formed in the vicinity of a shaft end of the pivot 22 at a left side. The angle sensor 90 and a casing for installing a display section (display section installing casing) 64 are installed at a portion of a further left shaft end of the flange portion 22a in this order toward the shaft end.

The flange portion 22a is a member formed integrally with the pivot 22. A dust-proof packing 22b made of an O-ring is installed at an outer circumference of the flange portion 22a. The dust-proof packing 22b is installed between the flange portion 22a and the display section installing casing 64. Therefore, it is possible to surely prevent refuse such as swarf and liquid from scattering or invading (or breaking) into the angle sensor 90 that is precision mechanical equipment. Installation of the dust-proof packing 22b allows a prevention effect of damage and a false operation of the angle sensor 90 to be obtained suitably.

The display section installing casing 64 becomes a state where the display section installing casing 64 can be tilted with respect to the pivot 22 integrally with the body portion 21 including the cover portion 27. Further, the calculation and display section 60 including the display section 62 is integrally installed on the display section installing casing 64. Moreover, a battery 65, which becomes a power source for the calculation and display section 60, is installed within the display section installing casing 64. This installation position of the battery 65 is a left side of the electric cutting tool 10′ and no impeditive member exists on its front surface. For that reason, the electric cutting tool 10′ has a configuration by which maintenance such as replacement of the battery 65 can be carried out very easily.

Further, although the battery 65 is installed at an installation portion of a lid member 64a that is opened and closed when the battery 65 is replaced, a dust-proof packing (not shown in the drawings) is installed between the lid member 64a and the display section installing casing 64. For that reason, a configuration is adopted in which it is possible to surely prevent refuse and liquid from invading into the inside of the display section installing casing 64 from a space between the lid member 64a and the display section installing casing 64.

The angle sensor 90 is installed at the position sandwiched between the flange portion 22a and the display section installing casing 64 described above. The angle sensor 90 included in the electric cutting tool 10′ is constructed from a first substrate 90a fixed to the display section installing casing 64 and a second substrate 90b fixed to the flange portion 22a. Since the first substrate 90a is fixed to the display section installing casing 64, the first substrate 90a carries out a rotary motion with a tilting action when the body portion 21 carries out the tilting action using the pivot 22 as the center of rotation. On the other hand, since the second substrate 90b is fixed to the flange portion 22a that is fixed and not rotated, the second substrate 90b always maintains a fixed state. Therefore, when a tilting action for the body portion 21 is carried out, the first substrate 90a carries out the rotary motion with respect to the fixed second substrate 90b. It is possible to grasp an amount of change of an angle of the tilting action for the body portion 21 by detecting an amount of change of the rotary motion. As a result, it is possible to measure a cutting depth of the circular saw blade 41 or the like.

In this regard, in the modified form example shown in FIG. 16 to FIG. 18, a configuration in which two members including the calculation and display section 60 and the angle sensor 90 are installed to the display section installing casing 64 provided with the battery 65 that is a power source is adopted. Thus, there are advantages that no wiring is required and the configuration has good assemblability compared with another embodiment and is excellent in a dust-proof function. Moreover, as is apparent from FIG. 16, the display section installing casing 64 and the calculation and display section 60 are arranged so as not to protrude from an outline of the body portion 21 including the cover portion 27. For this reason, even when the electric cutting tool 10′ is mounted in any posture, the display section installing casing 64 and the calculation and display section 60 are hardly in contact with the ground, and thus, troubles such as breakage never occur.

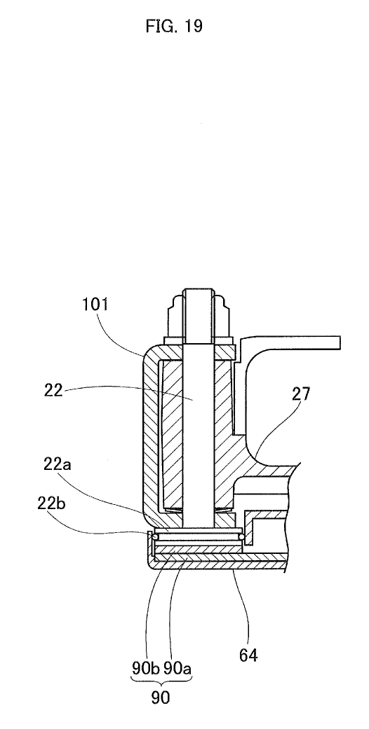

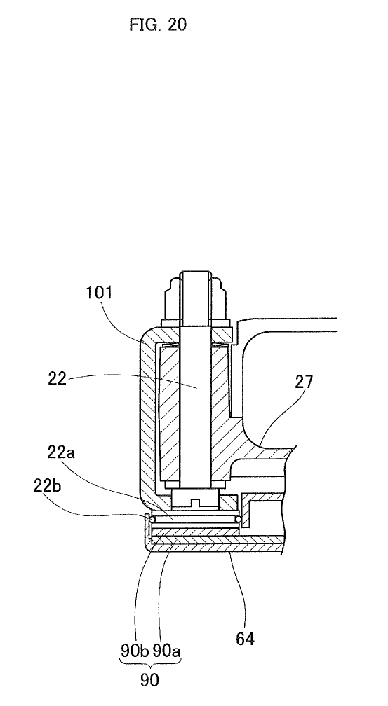

As described above, although the suitable modified form examples that the present invention can take have been explained, a further modified form can be adopted for the pivot 22 and the angle sensor 90. For example, the pivot 22 of the electric cutting tool 10′ shown in FIG. 18 in detail penetrates through the display section installing casing 64. However, as shown in FIG. 19, a configuration in which a shaft tip of the pivot 22 at the left side surface becomes a flange portion 22a, the angle sensor 90 and the display section installing casing 64 are installed at the outside of the flange portion 22a, and the pivot 22 is not directly in contact with the display section installing casing 64 can be adopted. Further, for example, the pivot 22 and the flange portion 22a of the electric cutting tool 10′ shown in FIG. 18 in detail are integrally configured. However, as shown in FIG. 20, a configuration in which a flange portion 22a is divided from a pivot 22 and each of the pivot 22 and the flange portion 22a is installed fixedly to the supporting member 101 can be adopted. In this regard, in the case of the configuration shown in FIG. 19 and FIG. 20, the pivot 22 does not penetrate through and protrude out of the display section installing casing 64 unlike the configuration shown in FIG. 18. Therefore, it is advantageous that refuse and liquid can be surely prevented from invading into the inside of the display section installing casing 64 (that is, the angle sensor 90).

Namely, as the forms of the members constructing the electric cutting tool according to the present invention, various kinds of modified forms can be adopted within a range capable of fulfilling the operations and effects of the present invention as described above.

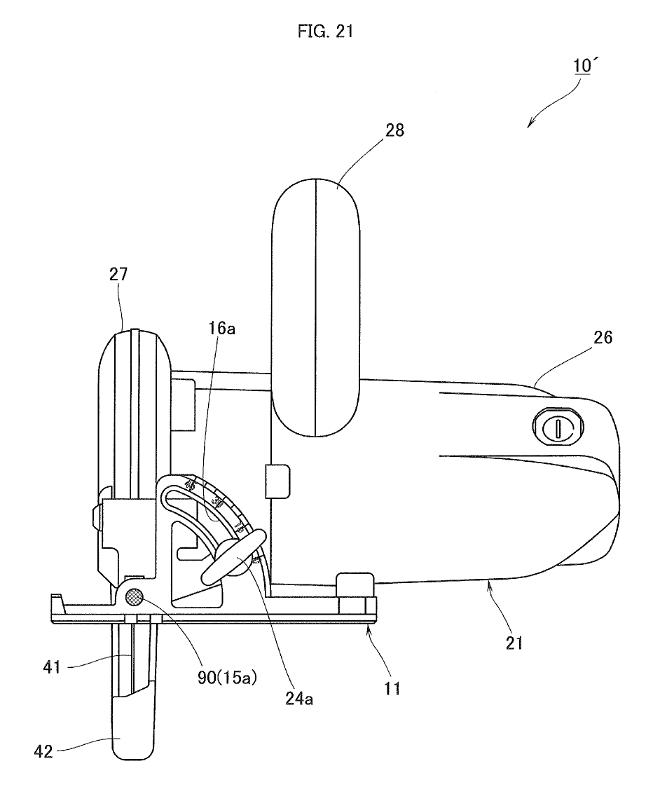

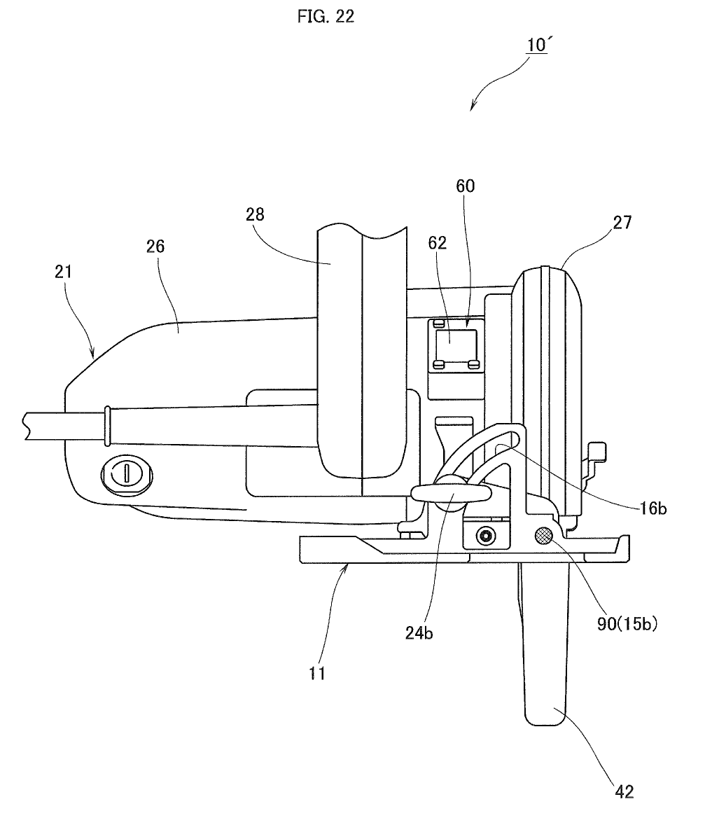

Moreover, as shown in FIG. 21 and FIG. 22, the movement amount measuring section (angle sensor 90) for detecting a movement amount as inclination angle data can be installed to the shaft members (15a, 15b), which become the center of a tilting action, in the horizontal direction of the body portion 21 with respect to the surface plate 11 (that is, a direction in which the circular saw blade 41 is to be tilted to the side surface). In this case, so long as the angle sensor 90 is installed to any one of the shaft members (15a, 15b), an object of measuring the movement amount as the inclination angle data is achieved. The angle sensor 90 installed in such a configuration allows the operator to obtain an inclination angle in the horizontal direction of the circular saw blade 41 with high accuracy. In addition, as shown in FIG. 18 and the like, one having a form configured by two members including the first substrate 90a and the second substrate 90b can also be adopted as the movement amount measuring section (angle sensor 90) for detecting a movement amount as inclination angle data.

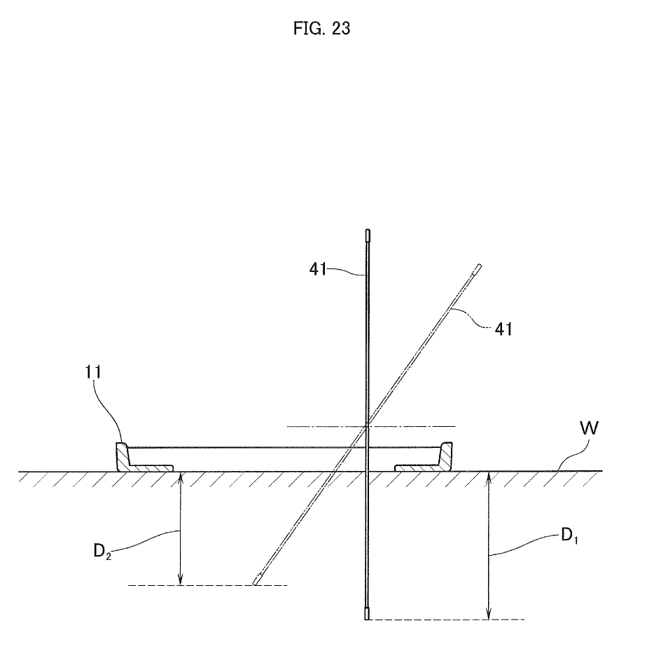

In this regard, in the case where the circular saw blade 41 is tilted in the horizontal direction, as shown in FIG. 23, a cutting depth in a perpendicular direction to a processed material W changes. Namely, in the case where an inclination angle of the circular saw blade 41 in the horizontal direction is not set, a cutting depth of the processed material W in the perpendicular direction is defined as a cutting depth D₁. In the case where an inclination angle of the circular saw blade 41 in the horizontal direction is set, a cutting depth of the processed material W in the perpendicular direction is defined as a cutting depth D₂. A relationship between the cutting depth D₁ and the cutting depth D₂ of course meets D₁>D₂. Therefore, in order to display a correct cutting depth on the display section 62, the movement amount measuring section is caused to detect an inclination angle of the circular saw blade 41 in the horizontal direction, and the calculating section 61 is required to carry out a correction process according to this tilt angle on the basis of the detected data. As the movement amount measuring section in this case, it is necessary to use both the movement amount measuring section for measuring the inclination angle data, such as the movement amount measuring section 50′ constructed by the magnetic scale 51′ and magnetic detecting head 52′, or the angle sensor 90, and the movement amount measuring section for measuring the moving distance data, such as the movement amount measuring section 50 constructed by the magnetic scale 51 and the magnetic detecting head 52, in combination. Adoption of such a configuration allows the cutting depth of the circular saw blade 41 to be obtained with high accuracy.

However, installation of both the movement amount measuring section (50′, 90 and the like) for measuring the inclination angle data and the movement amount measuring section (50 and the like) for measuring the moving distance data to the electric cutting tool is not a necessary requirement for the present invention. Any one of the movement amount measuring sections may be provided, or both of the movement amount measuring sections may be provided. Thus, any combination can be adopted. For example, in the case of the electric cutting tool in which only the movement amount measuring section for measuring moving distance data is installed, the cutting depth D₂ of the circular saw blade 41 in the perpendicular direction to the processed material W cannot be grasped when the circular saw blade 41 is tilted in the horizontal direction. However, a cutting depth in an oblique direction can be grasped. Namely, in the electric cutting tool according to the present invention, it is preferable to select a configuration of the movement amount measuring section and the like described above in accordance with various specific conditions such as use application of the electric cutting tool and a production cost.

Further, the case where the electric cutting tool 10 according to the present invention described above is configured as a handheld radial arm saw has been illustrated. However, the present invention can be applied to any other type of electric cutting tool within a range capable of fulfilling the similar operation and effect to the embodiments described above and various modified forms.

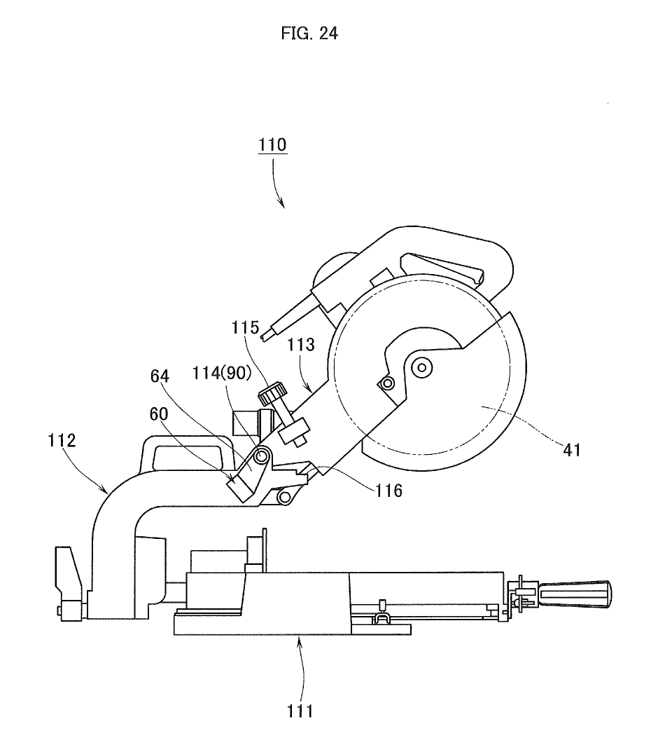

For example, the present invention can also be applied to a desktop type sliding circular saw 110 as shown in FIG. 24. In the case of this sliding circular saw 110, a table 111 and a tilt supporting section 112 correspond to the surface plate of the present invention, and a cutting machine body 113 corresponds to the body portion of the present invention. However, the cutting machine body 113 is installed to the tilt supporting section 112 attached to the table 111 in a tiltable state. The tilt supporting section 112 is connected to the cutting machine body 113 by means of a pivot 114. By attaching the calculation and display section 60 with the display section installing casing 64 or the angle sensor 90 to a portion of this pivot 114, it becomes possible to grasp a tilt movement amount of the cutting machine body 113, that is, a cutting depth of the circular saw blade 41.

In this regard, by providing an adjusting screw 115 as a lower limit stopper and a stopper abutting section 116 between the tilt supporting section 112 and the cutting machine body 113 to the sliding circular saw 110 shown in FIG. 24, it is possible to adjust a lower limit position of a tilting action of the cutting machine body 113. As for a method of adjusting the lower limit position, an amount of protrusion of the adjusting screw 115 can be adjusted in advance, or the lower limit position can be adjusted while viewing the display section 62 of the calculation and display section 60 in a state where the adjusting screw 115 abuts upon the stopper abutting section 116.

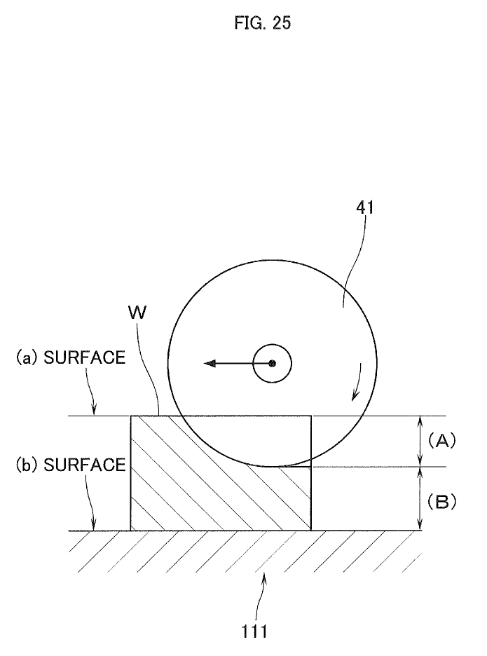

Moreover, as a method of adjusting a cutting depth of the desktop type sliding circular saw 110 shown in FIG. 24, as shown in FIG. 25, when the operator wants to grasp a cutting depth (A) with respect to a processed material W, an (a) surface, which is an upper surface of the processed material W, may be set as a point of origin (zero point). Further, when the operator wants to grasp a height (B) with respect to a base surface of the table 111, a (b) surface, which is the base surface of the table 111, may be set as a point of origin (zero point). Thus, compared with the desktop type sliding circular saw 110 in which the point of origin (zero point) must be adjusted in accordance with use application or an object of cutting, by providing the angle sensor 90 as the movement amount measuring section of the present invention, it is possible to realize an electric cutting tool with nonconventional high operability or improved processing accuracy.

It is apparent from the following claims that embodiments to which such changes and modifications are added can be included in a technical scope of the present invention.

What is claimed is:

1. An electric cutting tool comprising: a surface plate; a body portion tiltably provided on the surface plate; and a circular saw blade capable of rotating by means of driving power from a driver provided in the body portion, the electric cutting tool comprising:
a movement amount measuring section for measuring a movement amount of the body portion with respect to the surface plate in response to a tilting action;
a calculating section for calculating a cutting depth of the circular saw blade or an inclination angle of the body portion on the basis of the movement amount measured by the movement amount measuring section; and
a display section for displaying the cutting depth or the inclination angle of the body portion calculated by the calculating section.

2. The electric cutting tool according to claim 1, wherein the movement amount measuring section comprises:
a scale section installed on any one of the surface plate and the body portion, the scale section including scale marks provided at predetermined intervals; and
a scale detecting section for detecting the scale marks included in the scale section, the scale detecting section being installed on the other of the surface plate and the body portion.

3. The electric cutting tool according to claim 2, wherein the scale section is a magnetic scale in which the scale marks are recorded as magnetic patterns, and
wherein the scale detecting section is a magnetic detecting head for measuring the movement amount of the body portion with respect to the surface plate in response to the tilting action by reading out the scale marks from the magnetic scale and converting a read-out result into an electrical signal.

4. The electric cutting tool according to claim 2, wherein the scale section is a rack in which teeth for the scale marks are cut at predetermined intervals, and
wherein the scale detecting section is a pinion for measuring the movement amount of the body portion with respect to the surface plate in response to the tilting action by causing the pinion to carry out a rotary motion while engaging with the rack and detecting an amount of rotary motion.

5. The electric cutting tool according to claim 1, wherein the body portion includes:
a gripper used when a tilting operation of the body portion is carried out; and
a cover portion that covers an outer circumference of the circular saw blade,
wherein the display section is installed at a region between the gripper and the cover portion.

6. The electric cutting tool according to claim 1, wherein the body portion is configured so that the circular saw blade can be tilted in a direction to be tilted to a side surface of the electric cutting tool, and
wherein the calculating section calculates the cutting depth of the circular saw blade by carrying out correction in accordance with a tilt angle in a direction in which the circular saw blade is to be tilted to the side surface.

7. The electric cutting tool according to claim 1, wherein the movement amount measuring section, the calculating section and the display section are integrally installed by means of a casing.

8. The electric cutting tool according to claim 7, wherein the calculating section, the display section and the casing are arranged so as not to protrude from an outline of the body portion.

9. The electric cutting tool according to claim 1, further comprising:
a link member for linking the surface plate to the body portion, the link member extending along a tilt direction of the body portion from an upper surface of the surface plate,
wherein the movement amount measuring section includes an angle sensor for detecting an inclination angle of the link member with respect to the surface plate, and
wherein the calculating section calculates the cutting depth of the circular saw blade or the inclination angle of the body portion on the basis of the inclination angle detected by the angle sensor.

10. The electric cutting tool according to claim 1, wherein the body portion includes a cover portion that covers an outer circumference of the circular saw blade, the cover portion capable of tilting with respect to the surface plate together with the circular saw blade,
wherein the movement amount measuring section includes an angle sensor for detecting an inclination angle of the cover portion with respect to the surface plate, and
wherein the calculating section calculates the cutting depth of the circular saw blade or the inclination angle of the body portion on the basis of the inclination angle detected by the angle sensor.
